(19) United States
(12) Patent Application Publication
(10) Pub. No.: US 2002/0035897 A1
(43) Pub. Date: Mar. 28, 2002

(54) Suspension system and method for wellbore tubular makeup and breakout apparatus

(76) Inventors: Jean P. Buytaert, Houston, TX (US); Alain J. Miramon, Houston, TX (US); Dale J. Castille, Lafayette, LA (US)

Correspondence Address: THE MATTHEWS FIRM, 1900 West Loop South, Suite 1800, Houston, TX, 77027, US

(21) Appl. No.: 09/850,242

(22) Filed: May 7, 2001

Related U.S. Application Data
(63) Continuation-in-part of application No. 09/671,561, filed on Sep. 27, 2000.

(51) Int. Cl. B25B 17/00; B25B 13/50

(52) U.S. Cl. 81/57.35

(57) ABSTRACT

A power tong apparatus for making and breaking joints of well bore tubulars is provided for operation on a rig floor. A first extendable boom is provided for moving the power jaw apparatus across the rig floor. Preferably at least one wheel is mounted to a support frame to which the power tong apparatus is attached. The wheel steers the power tong apparatus as the boom extends and retracts. The wheel is pivotally mounted so that a non linear path may be followed when desired. In one embodiment, a track may be laid along a desired path on the rig floor. In another embodiment, a second extendable boom is mounted to said first boom for lifting the power tong apparatus. A pivotal connection may be provided between the second boom and the power tong apparatus to allow rotational movement thereof as connections are made or broken. The first boom is mounted on a pivot assembly that permits rotation of the first boom with respect to the rig floor. One or more lateral supports may be secured to the pivot assembly. In another embodiment, a single boom may be used.

### BACKGROUND OF THE INVENTION

1. Field of the Invention

The present invention relates generally to making up and breaking out wellbore tubulars and, more particularly, to apparatus and methods for a makeup and breakout tool that is conveniently mobile in a rig floor environment.

2. Related Application

The present application is a continuation-in-part of U.S. patent application Ser. No. 09/671,561, filed Sep. 27, 2000 and incorporated herein by reference.

3. Description of the Background

Makeup and breakout tools are used to spin, makeup, and breakout wellbore tubulars. It has been found by oil companies that separate, manually operated tongs, spinners, and/or chains are often significantly slower in making up and breaking out wellbore tubulars than a single tool or unit that does all such functions. The speed advantages of a single unit include factors such as eliminating the need to redress tongs when changing from drill pipe to collars and the integration of spinning with makeup and breakout functions. Due to the high daily cost of drilling rigs, the time savings can be substantial. Comparison studies between use of separate tongs and spinners as compared with a single unit makeup and breakout tool have shown cost savings that may range from one-quarter of a million to more than a million dollars per well. Another time saving advantage is that a self-contained unit can be used to makeup or breakout pipes at difficult positions in the rig or derrick-a feature that can save a great amount of time especially in certain situations that occasionally occur. For instance, when desired, pipes can be readily made up or broken out while in the mousehole with the rig otherwise occupied. An exemplary self-contained unit for making and breaking joints in pipe strings is shown in U.S. Pat. Nos. 5,868,045 and 5,386,746 which are incorporated herein by reference.

The self-contained system operates more reliably than separate tongs and spinners by providing a central torque regulator that connects to and controls all components to assure consistent makeup or break-out. This feature prevents thread damage caused by over-tightening and automatically prevents problems that could result in under-torqued connections.

The system eliminates accident conditions associated with separate independent tongs readily exposed on the floor, and the plurality of attendant separate cables used to pull on and support the separate tongs, and the use of snatch blocks. Safety is also improved because providing a single tool to perform all such functions rather than separate elements permits the use of central safety features such as, for instance, a lockout to prevent spinner operation if the tongs are not engaged, a safe location for the operator to stand and work, a design whereby the operator's hands and feet are safely away from moving parts, elimination of spinning chains, and a lockout to prevent operation of the lift cylinder when any tong is engaged.

Because of the great utility of a self-contained unit to makeup and breakout pipes, it would be highly desirable to make further improvements. For instance, a drilling/workover rig support line is normally secured to the top of the unit to support the unit and permit mobility of the unit. Even though the unit actually requires only one rig line as compared to at least two derrick rig support lines used to support separate tongs as well as least two other rig pull lines for pulling on separate tongs, it would nonetheless be desirable to eliminate the drilling rig support line for supporting the unit due to limited line availability. Moreover, because a self-contained unit will necessarily have considerable weight, effort is required, usually involving two people, to initially pull the makeup and breakout unit to the desired connection. While even these factors are at least on a par or typically better than use of separate tongs and spinners which require at least two drilling rig support lines and two pull lines and at least two or three people to operate the tongs and pull lines, nonetheless it would be desirable to control a makeup and breakout unit with a single operator using automated controls without the need for any rig lines.

One commercially available system uses two straight tracks wherein motored wheels move the make-up and break-out tool forward and backward. However, this configuration uses considerable rig floor space at all times, may not be used elsewhere on the rig floor, is very limited in operational positioning, and may be difficult to adapt to many rig floor arrangements.

Representative patents and publications seeking to solve such problems and related issues include the following:

U.S. Pat. No. 4,492,134, issued Jan. 8, 1985, to Reinholdt et al., discloses a power tongs for threadedly connecting together pipes which are to constitute casings for boreholes, which has a platform for a reciprocable slide which supports a power-driven threading clamp and a counter device. The clamp and the counter device are connected to each other by several level compensating hydraulic cylinders each of which is movable horizontally within limits relative to the slide against the opposition of resilient support elements. The upper end portions of the cylinders are connected to a holding plate for the clamp.

U.S. Pat. No. 4,082,017, issued Apr. 4, 1978, to Emery Eckel, discloses a hydraulically or pneumatically powered drill pipe tongs of the scissors-type used in making up or breaking apart joints of drill pipe, drill collars, and the like including an upper tong and a lower tong each including tong die heads for biting into or gripping the upper and lower joints of drill pipe, drill collars and the like with the upper and lower tongs being swivel connected and being swivelled by a hydraulically or pneumatically powered torqueing piston and cylinder assembly for rotating the upper and lower tongs in relation to each other when making up or breaking apart the drill pipe joints. Each of the upper and lower tongs includes a sliding door having one of the tong die heads thereon that can be moved a substantial distance toward and away from the tong body by the use of a pair of hydraulically or pneumatically powered piston and cylinder assemblies to enable tool joints, drill pipe protectors and the like to pass through the tongs while leaving the tongs on the pipe. Each of the tongs also includes a hinged mounting for one edge portion of the tong door and a latch for the other edge portion to enable the tong door to be latched or unlatched and swung outwardly in a manner to enable the tongs to be removed from the drill pipe when necessary.

U.S. Pat. No. 5,081,888, issued Jan. 21, 1992, to Joerg E. Schulze-Beckinghausen, discloses an apparatus for connecting and disconnecting threaded members including a power tong, a backup unit disposed below the power tong for tripping a second pipe, and apparatus for transmitting reaction forces generated by the power tong to the backup unit, the backup unit having devices for transmitting compressive or tensile forces between its members from the power tong which, in one embodiment, includes a hydraulic connection between a double acting hydraulic piston and cylinder assemblies incorporated in the members.

U.S. Pat. No. 6,138,776, issued Oct. 31, 2000, to Hart et al., discloses a pipe handling system comprising a rig floor supported frame adapted to be positioned above the rotary table and in alignment with the hole in the rotary table. It incorporates a centrally located bowl lined with the frame to enable a string of pipe to extend through the rotary table. Appropriate releasable slips are moved into and out engagement. The frame supports an overhead mounting plate, and one version thereof incorporates hydraulic jacks to raise and lower the mounting plate. The mounting plate supports a horizontally directed hydraulic ram which moves the two end lengths of a long multi length chain looped into a bight to go around a pipe passing near the end of the mounting plate. The bight in the chain grips the coupling of the pipe to hold it fast. This mechanism cooperated with an overhead power tong assembly to enable threading or unthreading of pipe casing and tubing.

U.S. Pat. No. 4,515,045, issued May 7, 1985, to Gnatchenko et al., discloses an automatic wrench comprising a high-torque, a low-torque, and a locking device. The wrench control system includes a torque detector and a rotation angle detector, in response to whose signals passing through an AND gate a control unit delivers a command to end the thread tightening by the rotation actuator of the high-torque device in screwing a pipe string together or to end the initial loosening of the thread with the aid of the same actuator in screwing it apart. The control unit incorporates a unit for monitoring the duration of the command execution, which stops operation of the high-torque device if no signal comes from said AND gate during the time allotted to accomplish the tightening or the initial loosening of the thread.

U.S. Pat. No. 5,271,298, issued Dec. 21, 1993, to Gilles Gazel-Anthoine, discloses a machine for screwing and unscrewing two rods, comprising an annular carcass forming a frame about a central axis and, staggered in height on the carcass, upper and lower wrenches each adapted to grip two successive rods. One of the wrenches, referred to hereinafter as the rotary drive wrench, is mounted rotatably relative to the carcass and the rotary drive wrench at least comprises a plurality of cams distributed circumferentially and each mounted to pivot about an axis parallel to the central axis between a retracted position in which they leave around the central axis a space sufficient for the rods to pass through and a deployed position in which they intrude on the space and are able conjointly to grip a rod present in the latter. The machine is useful in drilling installations.

U.S. Pat. No. 6,142,041, issued Nov. 7, 2000, to David A. Buck, discloses a power tong positioning apparatus, including a power tong support positionable on the surface of drilling rig deck and attachable to at least one power tong. The power tong support is adapted to position at least one power tong so that it may engage the tubular member. The power tong positioning apparatus a frame, a base moveably positioned on the frame, at least one arm pivotally attached to the base, a power tong support pivotally attached to the arm(s) and movably attachable to at least one power tong.

U.S. Pat. No. 6,142,040, issued Nov. 7, 2000, to Vernon J. Bouligny, discloses A spider, preferably a flush mounted spider, and powered lead tong which are coupled by a rotationally rigid structure so that torque reaction forces apply no side load to pipe. The tong preferably tilts upward to clear larger objects approaching the spider. An optional grabber is mounted, preferably atop the lead tong, and may tilt with the lead tong. Fluid powered motors, linear or rotary, provide the tilting energy and extend and retract the grabber. The tong and related structure has quick coupler provisions for removal from the spider.

Farrcanada provides a tong assembly on a track that moves along a track to engage the tubular connections as shown at website www.farrcanada.com.

The existing prior art does not disclose a suitable solution for the problems discussed hereinbefore. Consequently, there remains a need for a self-contained makeup and breakout unit that permits a single operator to perform the function of making and breaking the joints of wellbore tubulars. It would also be desirable to eliminate the requirement for a support line. However, it would be desirable to maintain the ability to use a line to permit the unit to be used in odd locations, for use on the mousehole or wellbore when desired, and/or for transport purposes. Those skilled in the art have long sought and will appreciate the present invention which provides solutions to these and other problems.

### SUMMARY OF THE INVENTION

The present invention was designed to provide more efficient operation to thereby reduce drilling costs, improve reliability of making and breaking pipe joints, permit increased automation to reduce required manpower, improve safety, and to free other rig equipment for other uses.

Therefore, it is an object of the present invention to provide an improved self-contained unit for making and breaking well bore tubulars.

Another object of the present invention is to have the ability to automate most of the functions of making and breaking of pipe joints for more efficient operation.

Yet another object of the present invention is to provide a means for powered three-dimensional movement of a self-contained pipe making and breaking unit.

Yet another object of the present invention is to free up equipment on a rig such as support lines.

An advantage of the present invention is improved rig safety.

Another advantage of the present invention is faster operation.

Yet another advantage is improved reliability and consistency in applying makeup or break-out torque to joint connections.

These and other objects, features, and advantages of the present invention will become apparent from the drawings, the descriptions given herein, and the appended claims.

Therefore, the present invention provides for a power jaw apparatus for making and breaking joints of well bore tubulars for use on a rig floor that may comprise elements such as one or more powered torque assemblies for applying torque to the joints of the well bore tubulars for the making and breaking of the joints of the wellbore tubulars and a support frame for supporting the one or more powered torque assemblies. A special feature of the invention comprises at least one wheel being mounted to the support frame. The invention may also comprise a first extendable boom which may be extendable and contractible in a first direction and a second extendable boom secured to the first extendable boom such that the second extendable boom may be extendable and contractible in a second direction. Other elements may include a connection between the second extendable boom and the support frame.

In one embodiment, the first boom is oriented substantially parallel to the rig floor, and the second boom is oriented substantially transverse with respect to the first boom. A pivotal connection may be secured to the first extendable boom for swiveling the first extendable boom with respect to the rig floor. The first extendable boom may further comprise a plurality of telescoping sections and, likewise, the second extendable boom may further comprise a plurality of telescoping sections.

In one embodiment, the second extendable boom is oriented with a vertical component to provide for relative vertical movement between the support frame and the rig floor. A connection between the second boom and the support frame may further comprise elements such as, for instance, a first arm, a second arm, and a swivel connection between the first arm and the second arm.

In other words, the invention may comprise elements, such as for instance, one or more powered torque assemblies for applying torque to the joints of the well bore tubulars, a support frame for supporting the one or more powered torque assemblies, a first boom oriented in a first direction, a second boom oriented in a second direction, and a connection between the support frame and the second boom.

In another embodiment, the invention may comprise elements such as one or more powered torque assemblies for applying torque to the joints of the well bore tubulars, a support frame for supporting the one or more powered torque assemblies, an extendable boom, a pivotal connection between the support frame and the extendable boom, and a pivotal connection for the extendable boom such that the extendable boom is pivotal with respect to the rig floor.

The apparatus may include a support member affixed with respect to the rig floor, and at least one brace for bracing the pivotal connection with respect to the support member.

A method for the invention may include steps, such as for instance, extending a first boom for moving the tong housing with respect to the rig floor, using at least one wheel to steer the tong housing around on the rig floor, pivoting the first boom such that the first boom is aligned for engaging the one or more torque assemblies with a respective of the joints of the tubulars, and lifting the tong housing for vertical engagement with the respective joint of the tubulars. In one embodiment the method may include steps such as utilizing a second boom oriented in a different direction from the first boom and/or swiveling the tong housing.

### BRIEF DESCRIPTION OF THE DRAWINGS

FIG. 1 is a perspective view of a self-contained makeup and breakout unit suspended on a support cable as used in the prior art;

FIG. 2 is an elevational view of an embodiment of the present invention with an extended horizontal boom and an extended vertical boom;

FIG. 3 is an elevational view of an embodiment of the present invention with an extended horizontal boom and an extended vertical boom;

FIG. 4 is a plan view of a rig floor with two different tracks;

FIG. 4A is a plan view of another embodiment of the present invention;

FIG. 4B is an elevational view of the embodiment of FIG. 4A in accord with the present invention;

FIG. 5A is a plan view of the embodiment of FIG. 4A in operation on the rig floor mousehole; and

FIG. 5B is a plan view of the embodiment of FIG. 5A moving off the mousehole in accord with the present invention.

While the present invention will be described in connection with presently preferred embodiments, it will be understood that it is not intended to limit the invention to those embodiments. On the contrary, it is intended to cover all alternatives, modifications, and equivalents included within the spirit of the invention.

### DETAILED DESCRIPTION OF THE PREFERRED EMBODIMENTS

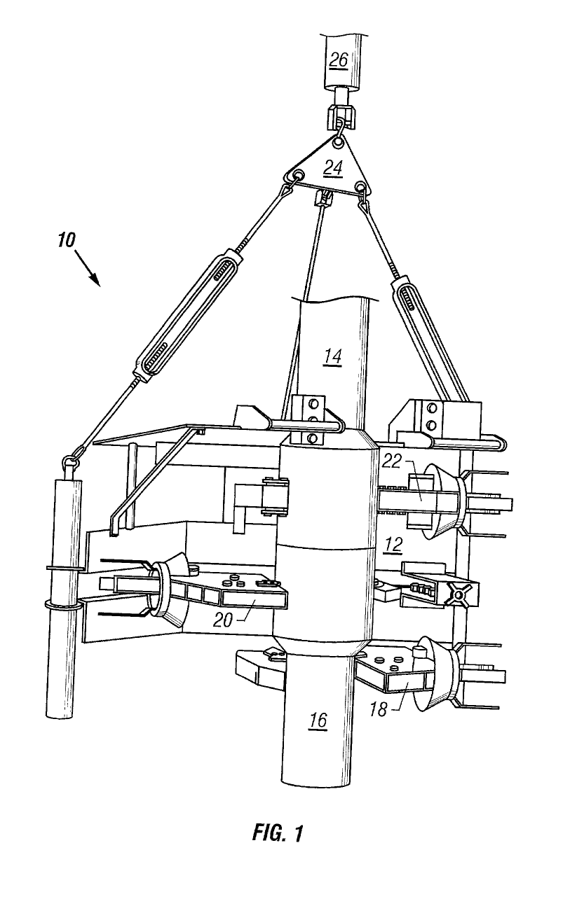

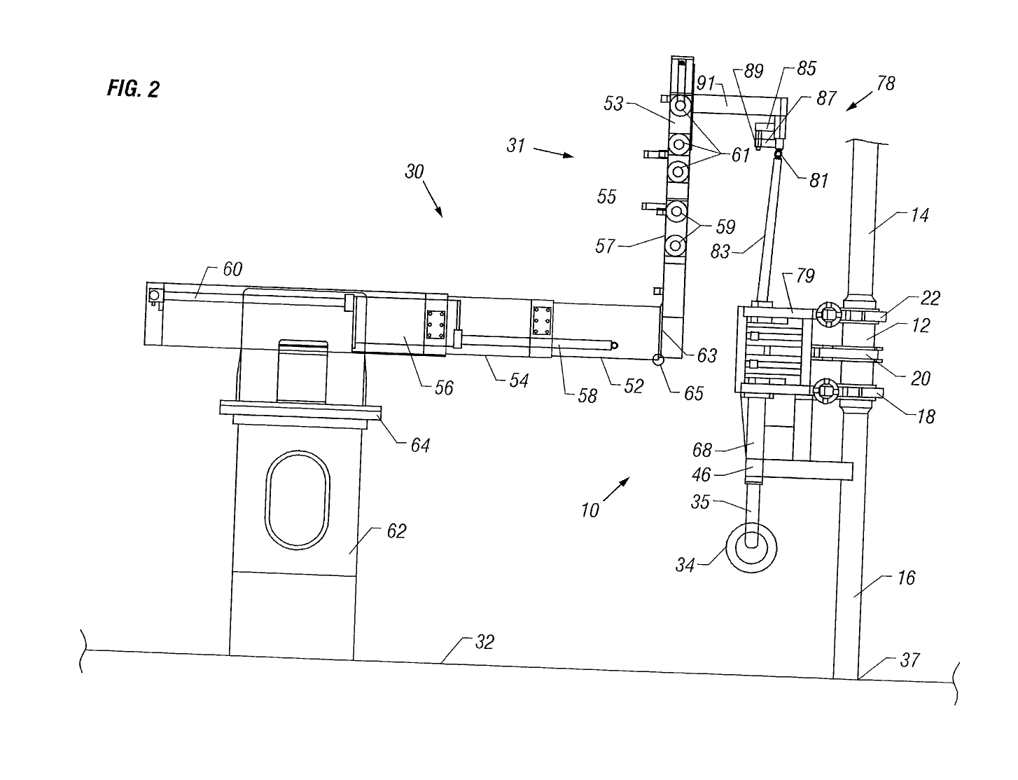

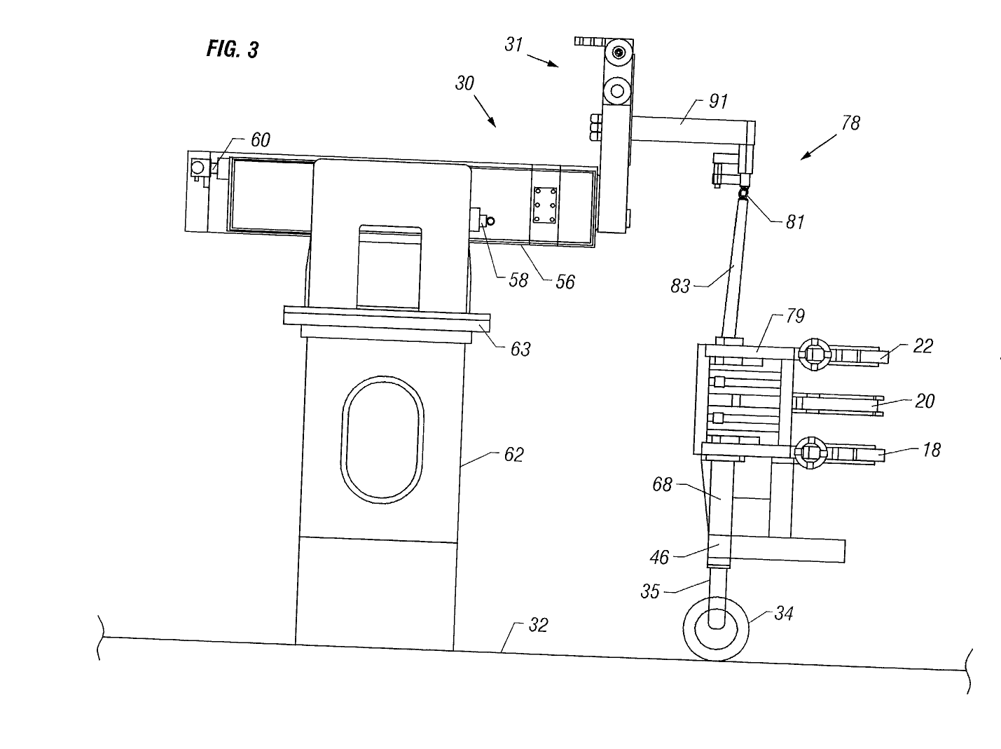

Referring now to the drawings, and more particularly to FIG. 1, FIG. 2, and FIG.3, which shows components 18, 20, and 22, which may be referred to generally as torque assemblies, tongs, wrenches, torque arms, jaws, or the like. Torque assemblies 18, 20, and 22 are secured together in a vertical orientation within self-contained unit 10 for making and breaking joints 12 of tubulars 14 and 16. For purposes of the present invention, the torque assemblies are considered to be any powered units or devices for applying torque to wellbore tubulars for making and/or breaking the joints thereof. The torque assemblies, such as torque assemblies 18, 20, and 22, may therefore take on numerous embodiments.

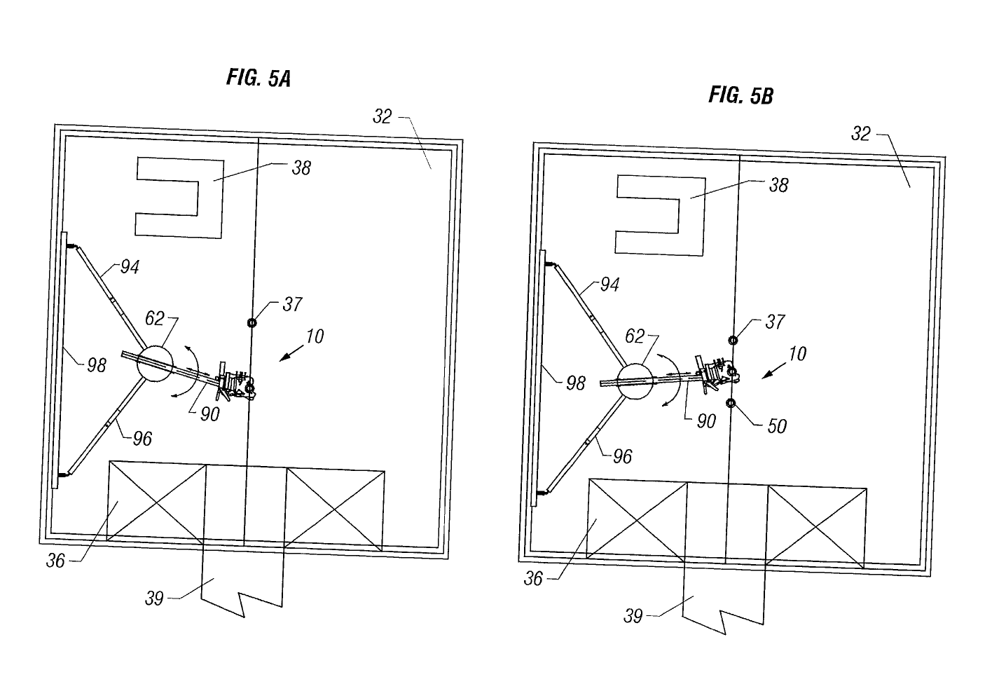

While tubulars 14 and 16 are normally substantially vertically oriented, unit 10 will preferably include a tilt mechanism whereby tubulars, such as those offset somewhat from the vertical, may be engaged by torque assemblies 18, 20, and 22. For instance, tubulars positioned in mousehole 50 (See FIG. 5B) may be offset from the vertical and unit 10 may still be used in various configurations of the present invention as discussed below to make and break connections of such tubulars located in the mousehole and elsewhere on the rig as well as the more typical making and breaking of tubulars positioned in wellbore 37. A prior art connection 24 to support line 26 is shown as has been used in the prior art. The present invention makes support line 26 optional and/or redundant as its role may now be limited to lifting the unit for storing purposes.

It will be understood that such terms as “up,” “down,” “vertical” and the like are made with reference to the drawings and/or the earth and that the devices may not be arranged in such positions at all times depending on variations in operation, transportation, and the like. As well, the drawings are intended to describe the invention so that the presently preferred embodiments of the invention will be plainly disclosed to one of skill in the art but are not intended to be manufacturing level drawings or renditions of final products and may include conceptual views as desired for easier understanding or explanation of the invention.

Referring now to FIG. 2 and FIG. 3, the present invention provides extendable first boom 30 and extendable second boom 31 arranged to move unit 10 on rig floor 32. The boom assemblies are discussed in more detail hereinafter.

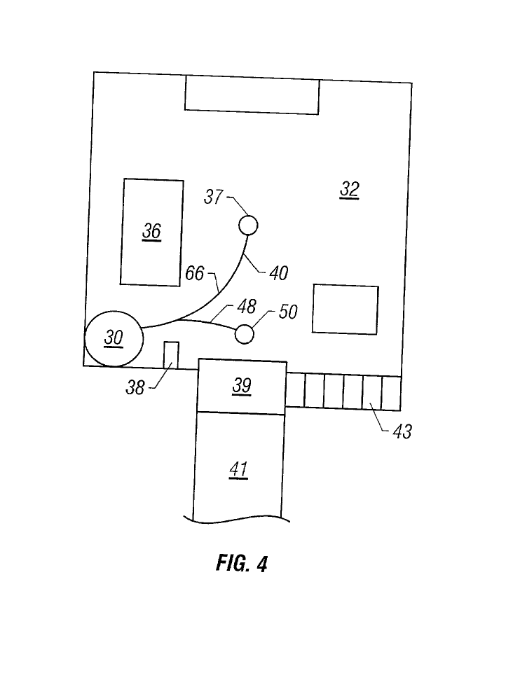

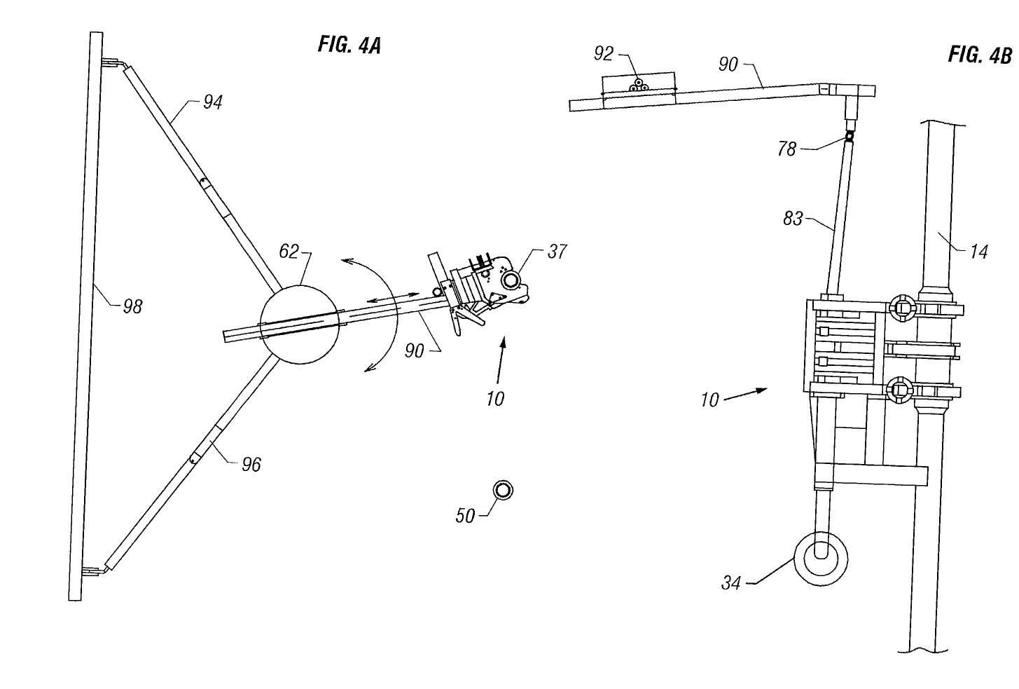

In one embodiment, wheel 34 is used to support the weight of unit 10, if desired, and may conveniently be positioned below unit 10. In one embodiment, wheel 34 is preferably located at the approximate center of gravity of unit 10. While one wheel is shown in a presently preferred embodiment, additional wheels including steerable and follower wheels could also be used, if desired. Moreover, unit 10 may be steered along rig floor 32 as indicated in FIG. 5A and FIG. 5B between obstacles 36 and 38 which may be stacked pipes, tools, driller room, or other equipment. V-door 39, as well as the catwalk (not shown) and stairs (not shown) may be used for introducing and removing drill pipe and/or other tools from rig floor 32. Wheel 34 may be pivotally mounted. If so, pivoting of wheel 34 may be effected in different ways, for example, support shaft 35 may pivot with respect to unit 10. In one embodiment, a track such as that shown in our previous application referenced hereinabove may be used to effect pivoting or steering of wheel 34 towards borehole 37. However, it will be understood that if a track is used, the track may be of many types and configurations so long as wheel 34 is steered as desired as discussed in more detail in my previous application referenced hereinbefore, and also with respect to FIG. 4 hereinafter. However, the invention is not necessarily limited to using a track to effect steering of unit 10. If necessary, other means to steer wheel 34 may be used such as a steering mechanism for steering or pivoting wheel 34, such as hydraulic steering mechanism 46. Various types of steering units could be used and controlled by an operator at a safe position. For instance, shaft 35 may include a rib whose relative rotational position is controlled by a rotatable member or sleeve or the like. As discussed in more detail in our previous application referenced hereinbefore, shaft 35 may also extend and retract with respect to unit 10 either in conjunction with such steering or not. Once a desired path of movement is selected, then it may be desirable that a computer memory be used to perform repetitive movements. The unit may be provided with both a track and manual steering as desired.

Extendable first boom 30 and/or extendable second boom 31 may, if desired, include a plurality of telescoping segments, such as for instance, telescoping sections 52, 54, and 56 or 53, 55, and 57, respectively. Various power means may be used to operate the booms. For instance on extendable first boom 30, hydraulic or pneumatic controls 58 and 60 of various types may be used for extending and retracting telescoping sections 52 and 54 with respect to section 56. Other operating means could also be used, for instance in extendable boom 31, chain drives are used that may include sprockets such as sprockets 59 and 61 and/or additional sprockets. Boom 31 could also be a substantially fixed boom or tower with elevator 91 slidably mounted thereon for lifting unit 10 as discussed hereinafter. In this embodiment, operation of boom 30 is independent of operation of boom 31. FIG. 2 shows the telescoping sections first boom 30 and second boom 31 in an extended position. FIG. 3 shows the same telescoping sections in a retracted position. It will be understood that booms 30 and 31 may be constructed in other ways with the effect of providing an extendable/retractable means for moving unit 10 about and/or above rig floor 32 in whatever position desired.

In this embodiment of the invention, boom 31 is joined to boom 30 at fixed joint 63. Joint 63 may include a hinge or pivot connection 65 such that boom 31 and boom 30 may pivot with respect to each other, if desired. A geared connection such as a rack and pinion or interlocking grooves or the like (not shown) could also form the joint such that boom 31 could be moved with respect to boom 30 such as up and down vertically whereby unit 10 is accordingly lifted and lowered as desired. In a presently preferred embodiment, first boom 30 is oriented in a first direction substantially horizontal to rig floor 32. Second boom 31 is oriented in a second direction transverse to boom 30 and may preferably be vertical with respect to boom 30. Other orientations could also be used, with the general object being to be able to move unit 10 in three dimensions so that boom 30 and boom 31 are preferably oriented in two different directions, which may if desired, be orthogonal with respect to each other.

As boom 30 is extended, then unit 10 may be moved in the desired direction such as toward borehole 37 assuming boom 30 is pivoted so as to be directed in that direction by means discussed hereinafter. When boom 30 is partially retracted, then unit 10 may be moved away from borehole 37 by a desired amount until the next pipe stand is positioned for making or breaking. When booms 30 and 31 are fully retracted, as shown in FIG. 3, then unit 10 may be stored in a corner of the rig floor while other functions occur, e.g., drilling, thereby leaving the rig floor relatively open. Moreover, booms 30 and 31 may be designed to be easily separable from unit 10 and act as a moveable boom for use as a tool on the rig floor, for lifting items to and from the rig floor, and the like so as to have multiple purposes besides movement of unit 10.

In a preferred embodiment, boom 30 is pivot mounted with respect to floor 32. Boom 30 may be mounted on pivotal support 62 that includes rotatable connection 64 that permits boom 30 to pivot or rotate with respect to floor 32. Since boom 30 is pivotally mounted, boom 30 can pivot to follow, if desired, movement of wheel 34 when wheel 34 is pivoted or steered by some means (not shown) along rig floor 32. Boom 30 may have other variations in construction and degrees of movement as desired depending on the purposes and conditions under which it is used.

In order that torque assemblies 18, 20, and 22 are positioned correctly with respect to joint 12 as shown in FIG. 2, means are preferably provided for moving unit 10 vertically upwardly and downwardly with respect to rig floor 32. In this embodiment, boom 31 provides vertical movement of unit 10 by movement of elevator 91. Elevator 91 may be affixed to telescoping boom 31 for vertical movement due to contracting and extending boom 31. Elevator 91 could also be mounted to slide or move with respect to boom 31 such as with a chain drive or gear drive. In any event, three dimensional movement of unit 10 is preferably provided.

Additionally, shaft 35 could be extendable. Thus, additional or combination means for vertical movement upwardly may be provided by hydraulic shaft 35 which may be controlled by hydraulic actuator 68. For instance, as hydraulic shaft 35 extends, unit 10 might move upwardly. In other words, by some means unit 10 is vertically moveable with respect to boom 30. In FIG. 3, unit 10 is in a lower vertical position relative to rig floor 32 whereas in FIG. 2, unit 10 is raised to a higher vertical position. Vertically moveable boom elements 53, 55, and 57 could also be connected in such a manner that shaft 35 provides most of the lifting power so that vertical boom 31 accommodates or provides secondary control movement of unit 10 rather than being the primary motivator. Thus, various means to lift unit 10 vertically could be provided, either separately or in combination, such as an extendable shaft 35, slidable elevator 91 with respect to boom 31, rack and pinion connection between boom 31 and boom 31, or an extendable boom 31. However, any means for lifting unit 10 could be used.

While in this presently preferred embodiment, second boom 31, preferably provides vertical lifting force, any mechanical connection which preferably provides vertical-only movement could be used in a presently desired embodiment of the invention such as a tower, lift, other types of arm and actuator arrangements, or other types of telescoping sections. However, if boom 31 or other elements provide a vertical component of movement of unit 10 but do not provide purely vertical movement, then some horizontal compensation means may also be necessary for controlling movement of unit 10 For example, unit 10 may preferably be laterally oriented with respect to pipes 16 prior to vertical movement whereby it would be desirable to maintain the same lateral position of unit 10 with respect to pipes 16 as unit 10 is lifted so as to require purely vertical movement. Thus, if purely vertical movement is not provided by boom 31 or other means and is required for the particular mode of operation, then lateral compensation or adjustments may be provided such as by extending or retracting boom 30.

A pivot connection 78 is preferably also provided between elevator 91 and support frame 79 of unit 10 whereby pivotal or rotational movement between unit 10 and boom 30 is permitted. An additional lifting shaft 83 may be included as part of support frame 79, as desired. However, in one embodiment shaft 83 could be replaced by a cable connection or the like, if desired.

During makeup and breakout, unit 10 will tend to pivot around joint 12. Pivot connection 78 may be constructed to permit such movement. As a preferred embodiment, pivot connection 78 may include multiple pivotal elements to permit a wide range of rotational movements. For instance, connection 81 may or may not be designed to pivot. As well, first arm 85 and second arm 87 may be connected with an additional pivot connection 89. Thus, arms 85 and 87 may be designed to permit rotation as desired.

For quick connecting or disconnecting of unit 10 to booms 30 and 31, connection 81 may effectively be a pin-socket hinge arrangement whereby the pin can be quickly retracted or inserted to connect or release unit 10 from boom 31. Thus unit 10 can be quickly connected or disconnected to boom 31 during assembly or disassembly. Alternatively, unit 10 could be disconnected and used elsewhere in the rig such as by means of suspension cable 26 without connection to boom 30 as may be desired in certain circumstances that may occasionally occur.

During operation, first boom 30 expands so that unit 10 is directed to the desired rig floor location such as adjacent borehole 37. As boom 30 expands, wheel 34, if used, may be steered toward borehole 37 by some means such as a track (see our prior application referenced hereinbefore for more details) or steering mechanism 46. When unit 10 is adjacent borehole 37, then boom 31 and/or extendable shaft 35 if used, may be extended or retracted as necessary so that respective of torque assemblies 18, 20, and 22 are vertically positioned for clamping and engaging joint 12 for making or breaking the connection. If used, then wheel 34 may preferably be retracted somewhat from rig floor 32. After torque assemblies are engaged to grip joint 10, then unit 10 is then also supported by connection to joint 12 which typically includes an entire drill string. The drill string can be affixed in position by use of slips, rig blocks and the like. During tong operation some rotation of unit 10 around borehole 37 may typically occur depending on the construction of unit 10. If necessary, pivot assembly connection 78 permits rotational or pivotal movement of unit 10 with respect to boom 30 and 31 when the connection is torqued. The rotational movement of unit 10 may typically be within 5 to 30 degrees of a circle during torquing. After joint 12 is torqued, then boom 31 and/or wheel 34 may be lowered, if necessary, and first boom 30 retracted to move unit 10 out of the way until the next joint is in the desired position for breaking.

Alternatively, boom 30 could remain substantially laterally extended and unit 10 left in substantially the same lateral position with respect to the pipe string, depending on the construction of unit 10, organization of the slips, other jobs to do on the rig floor, and whether the pipe string could be moved while unit 10 were still adjacent the pipe string. In this case, only vertical movement and/or lateral adjustments would be necessary during operation. The relative movements and positions may be quickly and easily effected by a button or switch so that manual positioning is not necessary.

One advantage of the present invention is that unit 10 may be steered along rig floor 32 as indicated in FIG. 4 between obstacles 36 and 38 which may be stacked pipes, tools, or other equipment. V-door 39, catwalk 41, and stairs 43 may be used for introducing and removing drill pipe and/or other tools from rig floor 32. Thus, wheel 34 is preferably pivotally mounted. Pivoting of wheel 34 may be effected in different ways, for example, support shaft 35 may pivot with respect to unit 10. In one embodiment, track 40 may be used to effect pivoting or steering of wheel 34 towards borehole 37. It will be understood that the track may be of many types and configurations so long as wheel 34 is steered as desired. Thus, track 40 may provide straight or curved sections. Track 40 may be of modular construction with curved portions and/or straight portions. A modular switch may be included as part of track 40 for switching between movement from track 40 to track 48. Track 40 may be raised or sunken from the rig floor. Track 40 may be an electronic track, such as a cable, waveguide, or the like. Track 40 may be a track in a computer control memory rather than a physical track on rig floor 32. Track 40 may include an arrangement of sensors. Track 40 may include and/or provide separate sensors at various positions on the rig. Track 40 may or may not be oriented linearly. Track 40 may be used to control straight and/or curved movement of unit 10. Track 40 may be oriented at a right angle, or at any other angle, to the borehole 37. Track 40 may be oriented in whole or in part along a radius of mousehole 50, or any other desired manner to effect movement of unit 10 horizontally along rig floor 32 to position the pipe within the torque arms for gripping. Thus, depending on the desired configuration, which may take many forms depending on the rig floor situation or other factors, track 40 can be used to steer unit 10 in a desired manner along rig floor 32. Unit 10 may be steered back and forth between two positions on track 40 or to and from different selectable positions along track 40, as desired.

However, the invention is not necessarily limited to using a track to effect steering of unit 10. Other means to steer wheel 34 may be used such as a steering mechanism for steering or pivoting wheel 34, such as hydraulic steering mechanism 46. Various types of steering units could be used and controlled by an operator at a safe position. For instance, shaft 35 may include a rib whose relative rotational position is controlled by a rotatable member or sleeve or the like. As discussed subsequently, shaft 35 may also extend and retract with respect to unit 10 either in conjunction with such steering or not. Once a desired path of movement is selected, then it may be desirable that a computer memory be used to perform repetitive movements. The unit may be provided with both a track and manual steering as desired. For instance, track 40 may be provided with a branch, such as branch 48, for movement to mousehole 50, whereby manual or automatic steering, track switching, or other means may be used to select movement of unit 10 along branch 48. Thus, mobility of unit 10 may be highly flexible as desired for a particular rig floor configuration. Because track 40 may be of modular construction, straight sections or modules, curved sections or modules, and switching sections or modules for branches such as branch 48, may be provided for easily and quickly constructing track 40.

FIG. 4A and FIG. 4B show yet another embodiment of the present invention wherein a single extendable boom 90 is used. Boom 90 can be pivoted, such as with pivot unit 62 discussed hereinbefore. A chain drive, such as chain drive 92, or other extendable means may be used to extend unit 10 inwardly and outwardly with respect to borehole 37. If desired, boom 90 may be pivotable upwardly and downwardly by using an embodiment of pivot unit 62 to enable lifting of unit 10 by angular movement of boom 90 with respect to the rig floor. Boom 90 may also include braces 94 and 96 mounted to support 98 that is affixed to the rig floor to provide additional support, especially if boom 90 is pivotally moveable upwardly and downwardly with respect to the rig floor. Braces 94 and 96 may also be extendable if desired for adjusting to different rig floor configurations. Pivot 68 may be affixed or not affixed to rig floor 32, as desired so as to be mountable wherever desired on rig floor 32. One or more wheels, such as wheel 34, discussed above, may be used with this embodiment, if desired.

FIG. 5A and FIG. 5B show examples of movement of unit 10 on rig floor 32 using extendable boom 90. In FIG. 5A, boom 90 moves unit 10 for operation on a pipe situated in mousehole 50. In FIG. 5B, boom 90 moves unit 10 away from mousehole 50 and may continue movement of unit 10 towards wellbore 37, as desired. Thus the embodiment of the present invention may be used for moving unit 10 wherever necessary on rig floor 32.

It will be seen that various changes and alternatives may be used that are contained within the spirit of the invention, some of which are discussed above. Various additional features may also be included such as but not limited to guides, safety rubber guard members on tracks or unit 10, and the like. The unit may be further combined or operated in conjunction with other devices such as automatic slip setting or pipe handling/racking tools.

The foregoing disclosure and description of the invention is illustrative and explanatory thereof, and it will be appreciated by those skilled in the art, that various changes in the size, shape and materials, the use of mechanical equivalents, as well as in the details of the illustrated construction or combinations of features of the various elements may be made without departing from the spirit of the invention.

What is claimed is:

1. A power jaw apparatus for making and breaking joints of well bore tubulars for use on a rig floor, comprising:
one or more powered torque assemblies for applying torque to said joints of said well bore tubulars for said making and breaking of said joints of said wellbore tubulars;
a support frame for supporting said one or more powered torque assemblies;
at least one wheel mounted to said support frame;
a first extendable boom, said first extendable boom being extendable and contractible in a first direction;
a second extendable boom secured to said first extendable boom, said second extendable boom being extendable and contractible in a second direction; and
a connection between said second extendable boom and said support frame.

2. The power jaw apparatus of claim 1, wherein:
said first direction is substantially parallel to said rig floor, and
said second direction is substantially transverse with respect to said first direction.

3. The power jaw apparatus of claim 1, further comprising:
a pivotal connection secured to said first extendable boom for swiveling said first extendable boom with respect to said rig floor.

4. The power jaw apparatus of claim 1, wherein said first extendable boom further comprises:
a plurality of telescoping sections.

5. The power jaw apparatus of claim 1, wherein said second extendable boom further comprises:
a plurality of telescoping sections.

6. The power jaw apparatus of claim 1, wherein said connection between said second boom and said support frame further comprises:
a first arm,
a second arm, and
a swivel connection between said first arm and said second arm.

7. The power jaw apparatus of claim 1, wherein said connection between said second extendable boom and said support frame further comprises:
a pivotal connection between said second extendable boom and said support frame.

8. The power jaw apparatus of claim 1, wherein said second extendable boom is oriented with a vertical component to provide for relative vertical movement between said support frame and said rig floor.

9. The power jaw apparatus of claim 1, further comprising:
a pivotal connection between said first extendable boom and said rig floor such that said extendable boom is pivotal with respect to said rig floor.

10. A power jaw apparatus for making and breaking joints of well bore tubulars, said power jaw apparatus being operable on a rig floor, comprising:
one or more powered torque assemblies for applying torque to said joints of said well bore tubulars;
a support frame for supporting said one or more powered torque assemblies;
at least one wheel mounted to said support frame;
a first boom oriented in a first direction;
a second boom oriented in a second direction; and
a connection between said support frame and said second boom.

11. The power jaw apparatus of claim 11, wherein:
said first direction is substantially parallel to said rig floor, and
said second direction is substantially transverse with respect to said first direction.

12. The power jaw apparatus of claim 11, further comprising:
a pivotal connection secured to said first extendable boom for swiveling said first extendable boom with respect to said rig floor.

13. The power jaw apparatus of claim 11, wherein said first extendable boom further comprises:
a plurality of telescoping sections.

14. The power jaw apparatus of claim 11, wherein said second extendable boom further comprises:
a plurality of telescoping sections.

15. The power jaw apparatus of claim 11, further comprising:
a pivot connection for said first boom such that said first boom is pivotally mounted.

16. A power jaw apparatus for making and breaking joints of well bore tubulars, said power jaw apparatus being operable on a rig floor, comprising:
one or more powered torque assemblies for applying torque to said joints of said well bore tubulars;
a support frame for supporting said one or more powered torque assemblies;
at least one wheel mounted to said support frame;
an extendable boom;
a pivotal connection between said support frame and said extendable boom; and
a pivotal connection for said extendable boom such that said extendable boom is pivotal with respect to said rig floor.

17. The power jaw apparatus of claim 17, wherein said extendable boom further comprises:
a plurality of telescoping sections.

18. The power jaw apparatus of claim 17, further comprising:
at least one brace for bracing said pivotal connection with respect to said rig floor.

19. The power jaw apparatus of claim 17, further comprising:
a support member affixed with respect to said rig floor, and
at least one brace for bracing said pivotal connection with to said support member.

20. A method for a power jaw apparatus for making and breaking joints of well bore tubulars on a rig floor, said power jaw apparatus comprising one or more powered torque assemblies for applying torque to said joints of said well bore tubulars, said one or more powered torque assemblies being mounted in a tong housing, said method comprising:
extending a first boom for moving said tong housing with respect to said rig floor, using at least one wheel to steer the tong housing around on the rig floor;
pivoting said first boom such that said first boom is aligned for engaging said one or more torque assemblies with a respective of said joints of said tubulars; and
lifting said tong housing for vertical engagement with said respective joint of said tubulars.

21. The method of claim 22, wherein said step of lifting further comprises:
utilizing a second boom oriented in a different direction as said first boom.

22. The method of claim 22, further comprising:
swiveling said tong housing.
